(19) United States
(12) Patent Application Publication
(10) Pub. No.: US 2011/0025548 A1
(43) Pub. Date: Feb. 3, 2011

(54) SYSTEM AND METHOD FOR VEHICLE SENSOR FUSION

(75) Inventor: JAMES N. NICKOLAOU, CLARKSTON, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/533,065

(22) Filed: Jul. 31, 2009

(51) Int. Cl. G01S 13/00

(52) U.S. Cl. 342/52

(57) ABSTRACT

A system and method is provided for tracking and evaluating targets sensed by one or more active safety sensors in a motor vehicle. The system and method tracks detected targets from one or more sensors as fused tracks, and determines the maturity and plausibility of such fused tracks in determining an appropriate response. This facilitates the reliable detection and evaluation of targets based on sensor data from different sensors.

### TECHNICAL FIELD

The present invention relates generally to vehicular systems and, more particularly, relates to vehicle safety sensors.

### BACKGROUND OF THE INVENTION

Modern vehicles are being designed to include a variety of sensors that can detect potential obstacles in the path the vehicle. When a potential obstacle is detected, the system can warn the driver of the obstacle. Additionally, in some implementations the system can itself take protective action, such as pre-filing the brakes or engaging an autonomous braking system.

In such a system it is of great importance to identify and correctly characterize potential obstacles in the path of the vehicle. Unfortunately, this task is made difficult by myriad of potential obstacles that may be in the vehicle's path. This problem is further complicated in systems that use a multitude of different sensors. For example, a system could include radar, camera, and laser sensing systems. Each of these sensing systems will have different performance, and will typically have a different field of view, i.e., will cover a different sensing area.

For example, some sensors will have a larger range, but be unable detect obstacles up close. Other sensors may be able to detect objects near the ground, while others can detect objects higher off the ground. An additional complication is that the various fields of view for the sensors can overlap.

These and other differences in the sensing performance systems makes it difficult for outputs to the sensors to combined and utilized together. This limits the effectiveness of the overall system in identifying and tracking potential obstacles.

Accordingly, it is desirable to provide an improved method and apparatus detecting potential obstacles that facilitates the combined use of data from a multitude of different sensing systems. Furthermore, other desirable features and functions of the present invention will become apparent from the subsequent detailed description of the invention and the appended claims, taken in conjunction with the accompanying drawings and this background of the invention.

### SUMMARY OF THE INVENTION

A system and method is provided for tracking and evaluating targets sensed by one or more active safety sensors in a motor vehicle. The system and method tracks detected targets from one or more sensors as fused tracks, and determines the maturity and plausibility of such fused tracks in determining an appropriate response. This facilitates the reliable detection and evaluation of targets based on sensor data from different sensors.

In one embodiment, the system and method evaluates targets sensed by each sensor cycle to determine if they are part of an existing fused track of targets. The method creates new fused tracks for targets not in an existing fused track, and records the number of sensors sensing a target for each fused track. The plausibility and maturity of fused tracks are computed to facilitate the evaluation and proper response to the targets.

To determine the maturity of fused tracks, the system and method tracks maturity values for each fused tracks based on the number of cycles a target in the fused track is seen. In such embodiments, maturity values are incremented and/or decremented based on whether a target is seen in a particular cycle, and if a target has moved or is moving into a blind spot box.

In various embodiments, the system and method evaluates the plausibility of each used fused track based on confidence levels of the sensors sensing the target in the fused track. Additionally, the system and method evaluates the plausibility of each used fused track based on the latitude and longitudinal range and rates of change of the targets in the fused track, the direction the fused track is moving, and if the fused track is within the vehicle path.

By tracking sensed targets as fused tracks, and evaluating the maturity and plausibility of fused targets, the system and method is able to effectively evaluate and facilitate the appropriate response to sensed targets.

### DESCRIPTION OF THE DRAWINGS

The present invention will hereinafter be described in conjunction with the following drawing figures, wherein like numerals denote like elements, and

FIG. 1 is a schematic view of an exemplary vehicle with a plurality of active sensors;

FIG. 2 is a functional block diagram of an exemplary sensor fusion system;

FIG. 3 is a schematic view of an exemplary host vehicle following an exemplary target vehicle;

FIGS. 4, 5 and 6 are flow diagrams illustrating exemplary methods for evaluating sensor data in accordance with an embodiment of the invention; and

FIGS. 7 and 8 are graphical views illustrating exemplary maturity values in accordance with an embodiment of the invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

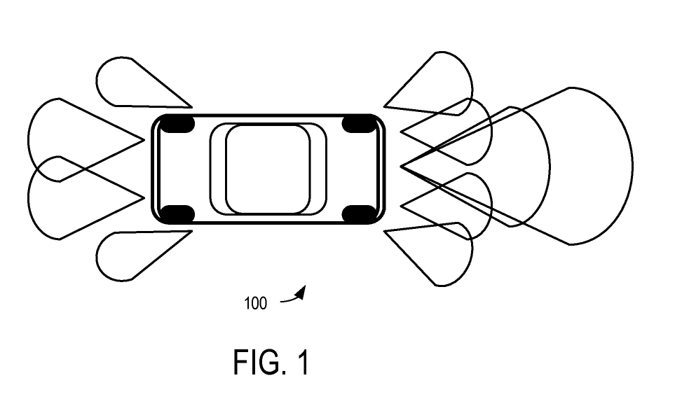

FIG. 1 is a schematic view of an exemplary vehicle 100 with a plurality of active sensors implemented as part of an active safety system. The plurality of active sensors can comprise any suitable arrangement and implementation of sensors. For example, the sensors can include laser sensors, radar sensors, and camera sensors. Each of these sensors uses one or more techniques for the sensing of detectable objects within their field of view. These detectable objects are referred to herein as “targets”.

In FIG. 1, the vehicle 100 includes long range sensors, short range sensors, mid-range sensors, short range sensors, and vehicle blind spot sensors (sometimes referred to as side sensors). Typically, the range of these sensors is determined by the detection technique employed. Additionally, for some sensors (e.g., radar) the range of the sensor is determined by the amount energy being emanated by the sensor, which can be limited by government regulation. The field of view of sensors may also limited by the configuration of the sensing elements themselves (i.e., the location of the transmitting element).

Typically, sensors are continually sensing, and provide information on any detected targets at a corresponding cycle rate. The various parameters used in determining and reporting the location of these targets will typically vary based on the type and resolution of the sensor.

Again, these sensors used various technologies and suitable. As illustrated in FIG. 1, the effective fields of view of these various sensors will commonly overlap significantly. Thus, a target near the vehicle may be commonly sensed by more than one sensor each cycle. The systems and methods of the various embodiments facilitate a suitable evaluation of targets sensed by one or more targets.

Typically, the system and method is implemented by configuring the sensors to provide data to a suitable processing system. The processing system will typical include a processor and memory to store and execute the programs used implement the system. It should be appreciated that these systems may be implemented in connection with and/or as part of other systems and/or other apparatus in the vehicle.

The processing system is configured to receive sensor data from the various sensors and evaluate the targets sensed by the sensors. To facilitate this, the processor can perform a variety of calculations and comparisons. For example, it can track detected targets from cycle to cycle, and can determine if a sensed target is part of a previously determined fused track or instead a new target that should be assigned to a new fused track. The processing system can also be configured to interface with other systems, such as collision avoidance and warning systems.

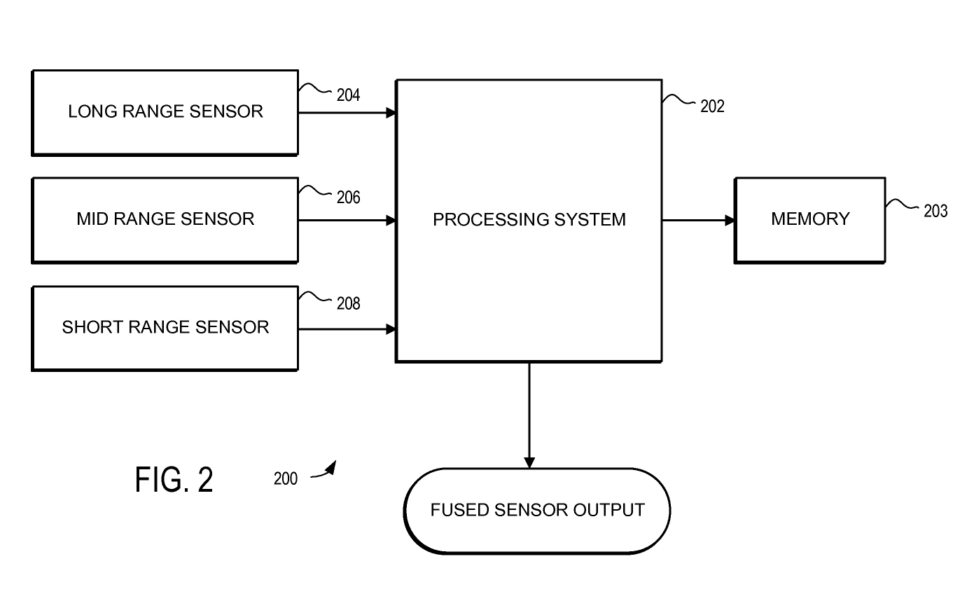

FIG. 2 is a functional block diagram of a sensor fusion system 200. In general, sensor fusion system 200 receives sensor data from a plurality of sensors, tracks detected targets from one or more sensors as fused tracks, and determines the maturity and plausibility of such fused tracks in determining an appropriate response. This facilitates the reliable detection and evaluation of targets based on sensor data from different sensors.

In the illustrated embodiment, the sensor fusion system 200 includes a processing system 202, a long range sensor 204, a mid range sensor 206 and a short range sensor 208. It should be noted that these sensors are merely examples of the type and number of sensors that can be used. Furthermore, it should again be noted that these sensors can use any suitable type of sensing technology.

Each of the sensors 204, 206 and 208 are coupled to, and configured to provide sensor data to the processing system 202. The system may also include a separate memory 203 to store the programs and values used to implement the system.

Preferably, the sensor fusion system 200 is configured to be implemented as part of, or in conjunction with, the vehicle control system. As such, the various elements of the sensor fusion system 200 may serve as various control and monitoring devices for the vehicle. For example, the various sensors and processing system 202 can be implemented in connection with a larger obstacle detection and avoidance (ODA) system.

In a typical embodiment, the long range sensor 204 will be a sensor capable of detecting well beyond the vehicle, such as a typical radar sensor used in such applications. Likewise, the mid range sensor 206 and short range sensor 208 will typically be a shorter range sensors, such as camera and ultrasonic sensors. In any cases, these sensors provide position information for any detected targets within their field of views to the processing system 202.

The processing system 202 is configured to receive this sensor data and determine the maturity and plausibility of fused tracks in the sensor data to determining an appropriate response. To facilitate this, the processing system 202 can perform a variety of calculations and comparisons. For example, it can perform calculations such as tracking target position data from cycle to cycle, comparing sensed values to various threshold values, etc. The processing system 202 can also be configured to obstacle avoidance, such as such as by warning the user of the vehicle, assisting with additional brake pressure when the driver does not apply the brakes sufficiently, or engaging autonomous braking.

In one embodiment, the processing system 202 is configured to evaluate targets sensed during each sensor cycle to determine if they are part of an existing fused track of targets. The processing system 202 creates new fused tracks for targets not in an existing fused track, and records the number of sensors sensing a target for each fused track. The processing system 202 computes the maturity and plausibility of fused tracks to facilitate the evaluation and proper response to the targets.

For example, to determine the maturity of fused tracks, the processing system 202 tracks the cycle counts for each fused tracks based on the number of cycles a target in the fused track is seen. In such embodiments, the cycle count is incremented and/or decremented based on whether a target is seen in a particular cycle, and if a target has moved or is moving into a sensing blind spot box. Additionally, the processing system 202 evaluates the plausibility of each used fused track based on confidence levels of the sensors sensing the target in the fused track, the latitude and longitudinal range of the targets in the fused track, the direction the fused track is moving, bounded similar range rate and azimuth rates of the targets in the fused track, and if the fused track is within the vehicle path.

Many such sensors have issues resolving road debris such as pop cans and tire fragments that can pop up when passed over by a leading vehicle. Because the debris will in many cases rise off the ground, they can be misinterpreted by the sensing system to be a much larger and more dangerous obstacle. This could lead to potential false activation of any semi-autonomous or autonomous collision avoidance system, and thus increase the possibility of false positive results in such systems.

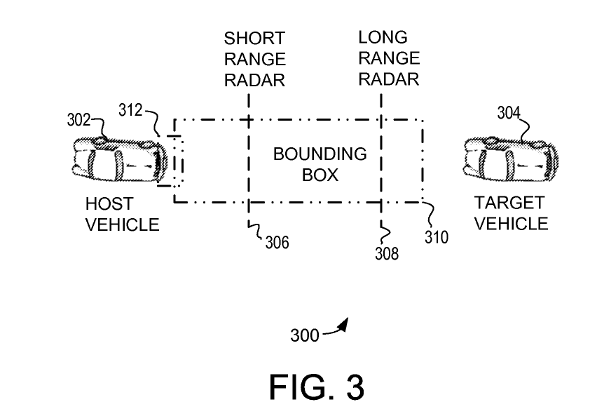

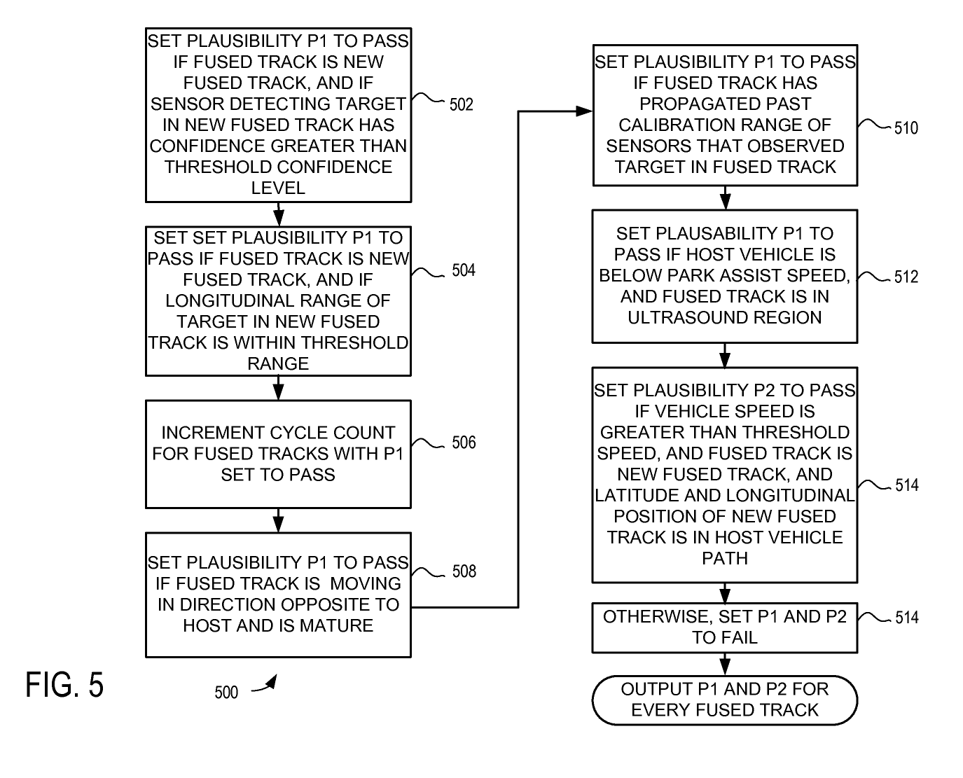

To facilitate the determination of fused track maturity and plausibility, the processing system 202 uses the concepts of a bounding boxes and minimum sensor distances. Turning to FIG. 3, schematic view 300 of an exemplary host vehicle 302 following an exemplary target vehicle 304 is illustrated. In this application, the host vehicle is the vehicle that includes the active sensor system. FIG. 3 illustrates an exemplary minimum sensor distance 306 for a short range radar, and a minimum sensor distance 308 for a long range radar. Also illustrated in FIG. 3 is an exemplary bounding box 310 and blind spot box 312. In general, the processing system uses the short range radar minimum sensor distance 306, and the long range radar minimum sensor distance 308, and the bounding box 310 in determining the plausibility of targets sensed by the short range radar and long range radar respectively. These distances will typically be configured to correspond to the minimum distances that the radars can reliably detect objects. As one example, these distances can correspond to the location where the radar intersects the ground. Thus, below that range the radar is likely to detect objects that are actually on the ground that should be ignored, such as sewer drains. The operation of the minimum sensor ranges in the use of determining plausibility values will be discussed in greater detail below with reference to FIG. 5.

The processing system likewise uses the bounding box 310 to identify objects in the path of the host vehicle as they are passed by the target vehicle. As one example, the bounding box 310 is configured with the processing system to extend from well before the of the short range radar to well beyond the range of the long range radar. Thus, the bounding box 310 will move with the host vehicle, and can include other traveling vehicles in the same lane. Targets sensed within the bounding box 310 are evaluated to determine if they are members of a fused track, and if not, are assigned to a new fused track. The fused track is used to track objects from cycle to cycle, even in the cases where the target temporarily disappears during some cycles. This is accomplished by only deleting those fused tracks that have not been sensed for a particularly long time or were never determined to have sufficient plausibility.

As one specific example, the bounding box 310 can be used with historical tracks of target vehicles and sensed targets and to determine which targets can be safely ignored. For example, if a target only appears in the bounding box 310 when driven over by the target vehicle (and thus was not tracked into the bounding box), it can be assumed that the object something is a type of debris that can be driven over. Thus, if the target vehicle's path intersects the target position trajectory is an indication that this target can be ignored.

Typically, the dimensions of the bounding box 310 would be determined by the range and accuracy ability of the sensors along with the physical dimensions of the host vehicle, target vehicle, and the velocities of the host and target vehicles. The operation of the bounding box 310 in the use of determining plausibility values will be discussed in greater detail below with reference to FIG. 5.

Likewise, the processing system uses the blind spot box 312 by continuing tracking of the targets that have entered the blind spot box 312 even when the sensors are no longer reporting the targets. For example, on some vehicles there can be about 0.5 meters of undetectable area in front of the vehicle. This occurs in vehicles that lack ultrasonic detectors and use only short range radar instead. The blind spot box 312 is an example of a front sensor blind spot box, as the corresponding blind spot is the area in which forward facing sensors cannot detect. It should be noted that the processing system could utilize other blind spot boxes, such as for the rear sensors, etc. In general, the blind spot box 312 is used to track targets into the blind spot box 312, and continue to track those targets in the blind spot box 312 as needed. To accomplish this, the processing system is configured to continue tracking targets in the blind sport box 312 as long as the vehicle is stationary. Once the host vehicle begins to move these targets are can be dropped as they propagate well past the front wheels of the host vehicle 302.

As one example, a pedestrian can enter the area corresponding to the sensor blind spot box 312. The processing system is configured to continue to track the pedestrian, as the pedestrian may remain in the area even though they are no longer being actively detected. However, in order to avoid tracking these objects after they are no longer an issue, the system is configured to drop these objects as the vehicle moves, as such objects would have then propagated well past the front wheels of the host vehicle 302.

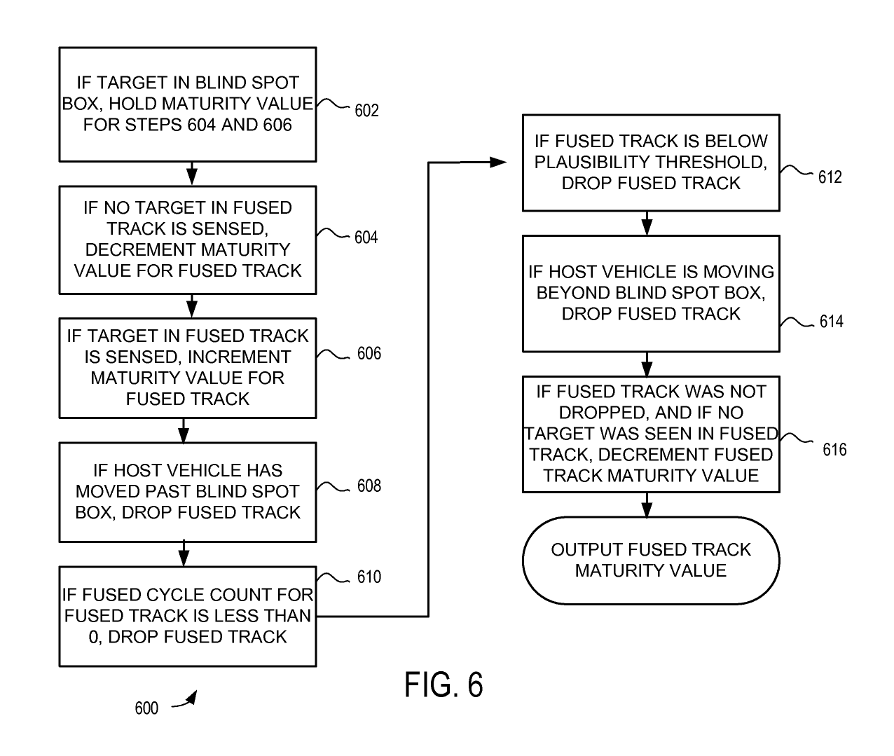

As such, the blind spot box 312 is configured to be that area that is directly in front of the target vehicle. As one example, the blind spot box 312 can be configured to be a rectangular area extending from 0.5 meters in front of the host vehicle to 2 meters under the host vehicle, with a width extending to the mirrors. As stated above, the processing system can use multiple blind spot boxes in its processing logic 202. An exemplary use of such blind spot boxes will be discussed with reference to FIG. 6.

As was noted above, to facilitate the plausibility and maturity of sensed object, the system tracks detected targets from one or more sensors as fused tracks. In general, a fused track includes the processed data from detections of sensed objects that are assumed to be part of one object or a collection of objects. A typical fused track can include data from multiple sensors, and will exist for multiple sensing cycles. A variety of data can be stored and processed for each fused track.

In one embodiment, the data for each fused track includes a fused track area corresponding to the current location of the targets in the fused track. This area can be defined with its dimensions (Xmin, Xmax, Ymin, Ymax) and a velocity (direction and speed). Additionally, the data for each fused track can include a sensor count that indicates the number of sensors that have detected targets in the fused track. Finally, the fused track data can include a cycle count tracking the number of sensor cycles that targets in the fused track have been detected. As will be described below, the sensor count and cycle count for each fused track can be used to determine the maturity and plausibility of such fused tracks, and thus can be used in determining an appropriate response. This again facilitates the reliable detection and evaluation of targets based on sensor data from different sensors.

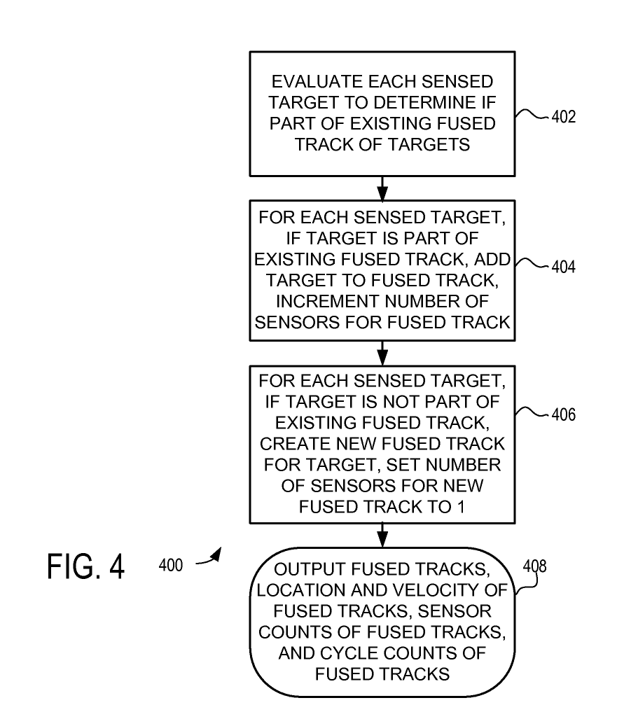

Turning now to FIG. 4, method 400 for processing sensor data inputs is illustrated. In general, the method 400 receives sensor data from the plurality of sensors evaluates detected targets to determine if the detected targets are part of previously detected object, or are instead detections of a new object. The first step 402 in method 400 is to evaluate each sensed target to determine if the sensed is part of an existing fused track of targets. As noted above, a fused track fused track includes the processed data from detections of sensed objects that are assumed to be part of one object or a collection of objects. In general, this step involves determining the position and velocity of a sensed target and determining if that sensed target corresponds to previously sensed targets that are part of an existing fused track.

For example, this step can be implemented by evaluating fused tracks to locate those similar grouping. In such a procedure, targets are compared to each fused track to determine if the position of the target (including latitude, longitude and velocity) are within calibrated bounds of another fused track. If so, the target can be merged with this fused track.

The next step 404 is to, for each sensed target, if the sensed target is determined to be part of an existing fused track, increment the number of sensors for that fused track. As noted above, the sensor count for each fused track is calculated and used to determine the plausibility of detected targets.

The next step 406 is to, for each sensed target, if the sensed target is determined to not be part of an existing fused track, to create a new fused track for that target, and set the sensor count for that fused track to 1. As noted above, this occurs when a new target is determined to not be within the calibrated bounds (including latitude, longitude and velocity) of another fused track.

In general, the steps 402, 404 and 406 are repeated until all sensed targets in a cycle are evaluated and assigned to fused tracks with any other sensed targets in those fused tracks, or assigned to a new track. The method 400 thus results in data that includes the fused track, the location and velocity of the fused tracks, the sensor counts for the fused tracks, and the cycle count of fused tracks.

Turning now to FIG. 5, a method 500 for processing sensor data inputs to determine plausibility is illustrated. In general, the method 500 receives the fused track data determined in method 500 and determines plausibility values for these fused tracks. In method 500 two plausibility values P1 and P2 are used. Each plausibility value can be set to either pass or fail. In general, a pass value for P1 indicates that the target has been sensed outside the minimum sensing distance of confident sensor. For example, pass value for P1 can be set to indicate that the latest sensor update first detect range exceeds the minimum allowable detection range for a short range radar or a long range radar (see the example illustrated in FIG. 3) Likewise, a pass value for P2 can be set to indicate that the target from any sensor is not appearing in the host virtual lane anywhere in the box drawn in FIG. 3 when following a target vehicle. In any case, the plausibility values can then be used to facilitate the evaluation and proper response to the targets

The first step 502 is to set plausibility P1 to pass for each fused track if the fused track is a new fused track, and if at least one sensor detecting a target in the new fused track has a confidence greater than a threshold confidence level. This step sets a high plausibility value fused tracks that includes targets that were detected by high reliability sensors. This allows the method to give high weight to sensors that have a high reliability of accurate detection. For example, a radar sensor that is known to locate targets with a high degree of confidence.

The next step 504 is to set plausibility P1 to pass for each fused track if the fused track is a new fused track, and if at least one target in the new fused track has a longitudinal range within a specified threshold. This step sets a high plausibility value fused tracks that includes targets that are in certain locations. This can be used to distinguish real obstacles from objects and structures that can be ignored.

For example, items such as sewer drains, construction plates, and metal grated road surfaces (i.e. metal bridges) tend to reflect at close in ranges, and can thus appear as larger stationary objects to some radars. When such an item is misinterpreted, it can incorrectly trigger a response, such as autonomous braking to avoid a potential collision. The plausibility P1 value serves as a filter to remove likely false targets by setting the plausibility to fail for those objects that the host vehicle can likely pass over safely.

The next step 506 is to increment the cycle count for fused tracks with plausibility P1 set to pass. This increases the cycle count for those fused tracks that have been sensed this cycle with high confidence.

The next step 508 is to set plausibility P1 to pass if the fused track is moving in a direction opposite to the host and is mature. In general this step designed sets the plausibility P1 to pass because mature objects that are moving in the opposite direction to the host vehicle are likely to be real objects. For example, when turning right onto a new road, a new target may be momentarily sensed in the host lane. Once the target begins to move away the classification would appropriately change and the host vehicle can react appropriately

The next step 510 is to set plausibility P1 to pass if the fused track has propagated past the calibration range of the sensors that detected one or more of the targets in the fused track. In general, this step sets the plausibility to pass for objects that were reliably detected because of their first seen target range but now would otherwise be misclassified. For example, a bicyclist may ride alongside the host vehicle and beyond the first detected range. This would otherwise set P1 to fail, but this step flips P1 to pass.

The next step 512 is to set plausibility P1 to pass if the host vehicle is below the park assist speed and the fused track is in the ultrasound region. This step is functions to use data from ultrasonic park assist sensors to confirm targets sensed by long range radar, short range radar, or cameras. This helps remove false positives and improve positive detections from close in targets with another set of disparate sensing technology.

The next step 514 is to set plausibility P2 to pass if the host vehicle speed is greater than the threshold speed, and if the fused track is a new fused track, and if the latitude and longitude position of the new fused track is in the host vehicle path. This step helps ensure that new road debris that comes up from under a target vehicle is classified correctly.

The next step 516 is to set otherwise set plausibility P1 and P2 to fail. Thus, those fused tracks that do not have plausibility values set to pass in steps 502-514 are set to fail in step 516.

In general, the steps 502-504 are repeated for all fused tracks, including any new fused tracks and any preexisting fused tracks. The method 500 results in set plausibility values P1 and P2 for each fused track, including new and preexisting fused tracks. These plausibility values can then be used to determine how to respond to the sensor data.

Turning now to FIG. 6, a method 600 for processing sensor data inputs to determine maturity is illustrated. In general, the method 600 receives the fused track data determined in method 400 and 500 and increments and decrements maturity values for each fused track as appropriate. In one embodiment, a cycle count corresponding to how many sensor cycles a fused track has been observed is used to provide the maturity values of the fused tracks. The higher the cycle count, the more targets in the fused track have been seen, and the more mature a fused track can be considered to be. Fused tracks above a certain threshold value of cycle count can be considered more mature, while fused tracks with cycle counts below a threshold value can be considered immature, and fused tracks with cycle counts below a lower threshold can be dropped.

The first step 602 is to determine a sensed target has moved into a blind spot box, and to hold the maturity value for steps 604 and 606 if the sensed target is in the blind spot box. As was noted above with reference to FIG. 3, a blind spot box is a location where sensors cannot currently detect a target. However, as such a target is still likely to exist, the step 602 ensures that the maturity value for an object that has just moved into a blind spot box is not immediately decremented. Thus, if the system has determined that the targets of the fused track have moved into the blind spot box, the maturity values are held and not decremented in steps 604 and 606.

In the next step 604, if no target in the fused track is sensed this cycle, the maturity value for the fused track is decremented. Thus, in step 604 all fused tracks (except those corresponding to objects in the blind spot box) are decremented if no target in the fused track is sensed in this cycle.

In the next step 606, if no target in the fused track is sensed, the maturity value for the fused track is incremented. Thus, in step 606 all fused tracks are have their maturity value incremented if a target in the fused track has been sensed this cycle.

In the next step 608, if the host vehicle has moved past the blind spot box, the fused track is dropped. This ensures that objects that are no longer possibly in the path of the vehicle are no longer tracked or evaluated.

In the next step 610, if the maturity value for the fused track has been decremented to less than zero, the fused track is dropped. Again, this ensures that objects that are no longer likely to be in the vehicle path are no longer tracked or evaluated.

In the next step 612, if the fused track has a plausibility below a threshold value, the fused track is dropped. Again, this ensures that objects that are no longer likely to be in the vehicle path are no longer tracked or evaluated.

In the next step 614, if the vehicle is moving beyond the blind spot box, the fused track is dropped.

In the next step 616, if the fused track was not dropped, and if no target was seen in fused track, the cycle count for the fused track is decremented.

In general, the steps 602-616 are repeated for all fused tracks, including any new fused tracks and any preexisting fused tracks. The method 600 results in set maturity values that updated for recent detections of objects, and that fused tracks that have dropped below certain levels of maturity have been removed. The determined maturity levels reflect the cycle counts that targets in the fused tracks have been seen, and can then be used with the plausibility values can then be used to determine how to respond to the sensor data.

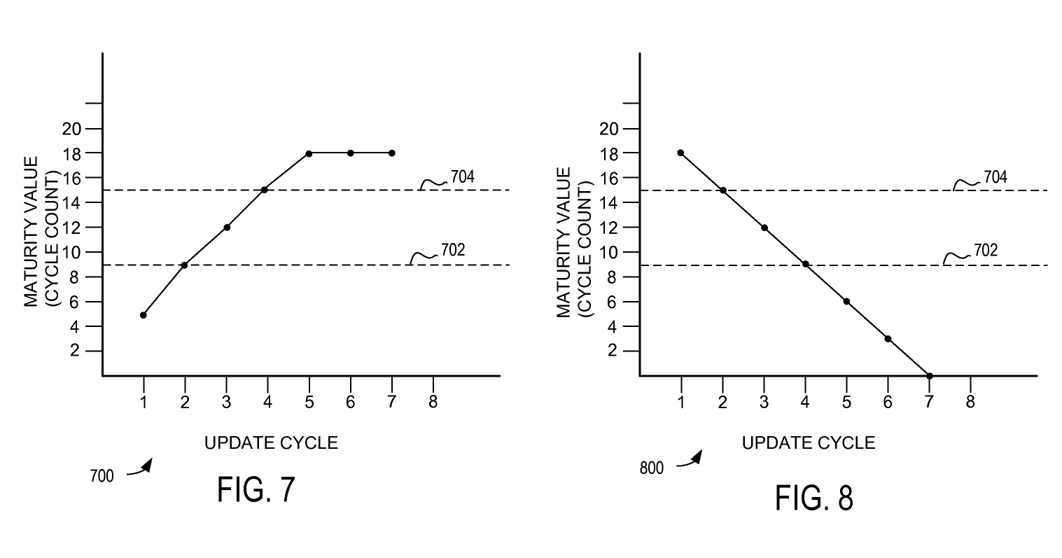

Turning now to FIG. 7, a graph 700 illustrates how the exemplary maturity of fused tracks can change. In the example of the FIG. 7, the maturity values are updated with changes to cycle count as described above. In accordance with one embodiment, fused tracks having a maturity below a first threshold 702 each fused track are considered to be immature. Fused tracks having a maturity above a second threshold 704 are considered to be mature. Fused tracks having a maturity between the first threshold 702 and the second threshold 704 are considered to have a tentative maturity.

In the illustrated example, the first threshold 702 below which fused tracks are considered to be immature is set at a value of 9. Likewise, the second threshold 704 above which fused tracks are considered to be mature is set at 15. It should be noted that these are just examples of where these and other threshold values can be set.

A new fused track is created when a target object is identified that does not belong to any existing fused tracks. As was described above with reference to FIG. 4, this process involves comparing targets to existing new fused tracks and creating new fused tracks as needed. New fused tracks are then given an initial maturity value. In the example of FIG. 5, the maturity value of a new track corresponds to a cycle count of 5. Thus, when a new fused track is created, it is assigned to an initial maturity value of 5. Assigning such a relatively high initial maturity value assures that new fused tracks are not immediately removed even if the target objects in the fused track are not detected again. Specifically, as the cycle count of a fused track is decremented only once per cycle (e.g., step 604 in method 600) the fused track is guaranteed to exist for at least five cycles (until the cycle count is decremented to 0) even if it is not detected again.

At its initial creation, the maturity value is set to 5. This is below the first threshold 702, and thus the fused track would be considered immature at this point. In the example of FIG. 7, the maturity value is incremented in the update cycles 2-5. At update cycle 2, the maturity value crosses the first threshold 702, and the fused track would be considered tentative. At update cycle 15, the maturity value crosses the second threshold 704 and the fused track would be considered mature. Also, in this example, the maturity value reaches a maximum value of 18 at update cycle 5, and stays there through update cycle 8.

Turning now to FIG. 8, a graph 800 illustrates how the exemplary maturity of fused tracks can change. Again, in accordance with one embodiment, fused tracks having a maturity below a first threshold 702 each fused track are considered to be immature. Fused tracks having a maturity above a second threshold 704 are considered to be mature. Fused tracks having a maturity between the first threshold 702 and the second threshold 704 are considered to have a tentative maturity.

In the example of FIG. 8, the maturity of the fused track is decremented during each cycle. This can occur in response to no objects in the fused track being seen during cycle (e.g., step 604 in method 600). This continues until the maturity value reaches a point at which it may be dropped. For example, the fused track can be dropped when the fused track drops to zero (e.g., step 610 in method 600). In the example of FIG. 8, that occurs at cycle 7.

It should be noted that the relative slopes of the increments and decrements can be adjusted to insure that the tracks are not matured too slowly, or dropped to quickly.

The tracked maturity values shown in FIGS. 7 and 8 are passed to the various vehicle systems and used to determine what response, if any, is appropriate to the fused track. For example, an autonomous braking system may pre-fill brakes when fused tracks reach a tentative maturity, and may activate brakes when fused tracks reach a mature maturity. Of course, this is just one simplified example, and in most cases the systems could responds based on a variety of factors.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for tracking targets sensed by sensors in a host motor vehicle, the method comprising the steps of:
determining if a first target is part of an existing fused track in a plurality of fused tracks, where each of the plurality of fused tracks includes one or more sensed targets;
adding the first target to an existing fused track if the first target is determine to be part of an existing fused track of targets; and
creating a new fused track and adding the first target to the new fused track if the first target is determined to not be part of an existing fused track of targets.

2. The method of claim 1, further comprising the step of:
determining a first plausibility for each of the plurality of fused tracks.

3. The method of claim 2, wherein the step of determining the first plausibility for each of the plurality of fused tracks comprises:
determining a confidence level of a sensor detecting a target in the fused track.

4. The method of claim 2, wherein the step of determining the first plausibility for each of the plurality of fused tracks comprises:
determining a longitudinal range, a lateral range, and a range rate of a target in the fused track.

5. The method of claim 2, wherein the step of determining the first plausibility for each of the plurality of fused tracks comprises:
determining if a target in the fused track is moving an direction opposite to the host motor vehicle.

6. The method of claim 1, further comprising the step of:
determining a second plausibility for each of the plurality of fused tracks by determining a speed of the host vehicle and determining if a target in the fused track is in a path of the host vehicle.

7. The method of claim 1, further comprising the step of:
determining a maturity value for each of the plurality of fused tracks.

8. The method of claim 7, wherein the step of determining the maturity value for each of the plurality of fused tracks comprises:
assigning an initial maturity value for new fused tracks;
incrementing the maturity value for fused tracks where a target is detected in a sensing cycle; and
decrementing the maturity value for fused tracks where a target is not detected in the sensing cycle.

9. The method of claim 7, wherein the step of determining the maturity value for each of the plurality of fused tracks comprises:
holding the maturity value for fused tracks where a target has moved into a sensor blind spot box.

10. The method of claim 7, further comprising the step of:
dropping fused tracks where the maturity value drops below a threshold value.

11. A system for tracking targets in a host motor vehicle comprising:
a first sensor configured to sense targets proximate to the host motor vehicle, the first sensor having a first range;
a second sensor configured to sense targets proximate to the host motor vehicle, the second sensor having a second range;
a processor coupled to the first sensor and the second sensor, the processor configured to:
determine if a first target is part of an existing fused track in a plurality of fused tracks, where each of the plurality of fused tracks includes one or more sensed targets being tracked by the processor;
add the first target to an existing fused track if the first target is determine to be part of an existing fused track; and
create a new fused track and add the first target to the new fused track if the first target is determined to not be part of an existing fused track.

12. The system of claim 11, wherein the processor is further configured to determine a first plausibility for each of the plurality of fused tracks.

13. The system of claim 12, wherein the processor is further configured to determine the first plausibility for each of the plurality of fused tracks by:
determining a confidence level of a sensor detecting a target in the fused track.

14. The system of claim 12, wherein the processor is further configured to determine the first plausibility for each of the plurality of fused tracks by:
determining a longitudinal range, a lateral range, and a range rate of a target in the fused track.

15. The system of claim 12, wherein the processor is further configured to determine the first plausibility for each of the plurality of fused tracks by:
determining if a target in the fused track is moving in an direction opposite to the host motor vehicle.

16. The system of claim 11, wherein the processor is further configured to determine a second plausibility for each of the plurality of fused tracks by determining a speed of the host vehicle and determining if a target in the fused track is in a path of the host vehicle.

17. The system of claim 11, wherein the processor is further configured to determine a maturity value for each of the plurality of fused tracks.

18. The system of claim 17, wherein the processor is further configured to determine the maturity value for each of the plurality of fused tracks by:
assigning an initial maturity value for new fused tracks;
incrementing the maturity value for fused tracks where a target is detected in a sensing cycle; and
decrementing the maturity value for fused tracks where a target is not detected in the sensing cycle.

19. The system of claim 17, wherein the processor is further configured to determine the maturity value for each of the plurality of fused tracks by:
holding the maturity value for fused tracks for at least one sensing cycle where a target has moved into a blind spot box.

20. The system of claim 17, wherein the processor is further configured to determine the maturity value for each of the plurality of fused tracks by:
dropping fused tracks where the maturity value drops below a threshold value.
